(19) United States
(12) Patent Application Publication
(10) Pub. No.: US 2009/0317203 A1
(43) Pub. Date: Dec. 24, 2009

(54) SPIRAL FLUTED TAP

(75) Inventors: Takayuki Nakajima, Toyokawa-shi (JP); Takayuki Matsushita, Toyokawa-shi (JP); Jiro Osawa, Toyokawa-shi (JP)

Correspondence Address: OLIFF & BERRIDGE, PLC, P.O. BOX 320850, ALEXANDRIA, VA, 22320-4850, US

(73) Assignee: OSG CORPORATION, Toyokawa-shi (JP)

(21) Appl. No.: 12/448,276

(22) PCT Filed: Dec. 18, 2006
(86) PCT No.: PCT/JP2006/325210

§ 371 Date: Jun. 16, 2009

(51) Int. Cl. B23G 5/06

(52) U.S. Cl. 408/230; 470/198

(57) ABSTRACT

As shown in FIG. 1, rake surfaces of cutting edges 26 of a shank-side thread portion 24b formed in a full thread portion 24 are formed with chamfers 30 having the chamfer height Hmen fallen within the range of 15% to 100% of the thread height Hneji. This allows chips to be further easily pushed out toward an outer circumferential area along the chamfers 30. In addition, the cutting edges 26 can have the increased strength thanks to formation of the chamfers 30. This effectively prevents occurrence of chipping and breakage resulted from the biting of the chips. Further, the chamfer-side thread portion 24a formed on the full thread portion 24 at the distal end is contiguous to the chamfer portion 22, which has an original complete thread configuration with more than one thread and not more than five threads. In addition, the shank-side thread portion 24b formed with the chamfers 30 has an original thread configuration except areas around the cutting edges 26. Thus, the entire area of the full thread portion 24 can have the excellent guide actions (in lead feed). This can tap the internal threads with high working precision.

### TECHNICAL FIELD

The present invention relates to a spiral fluted tap, and more particularly, to a technology of preventing occurrence of chipping or breakage resulted from a biting of chips, especially when a full thread portion is screwed into a threaded bore formed by a chamfer portion.

### BACKGROUND ART

There has been a kind of a spiral fluted tap, disclosed in for instance Patent Publication 1, which has a threaded portion formed with cutting edges extending along spiral flutes so as to divide or to segmentalize external threads. Screwing the threaded portion into a prepared hole allows the cutting edges to cut or to tap internal threads on an inner circumferential surface of the prepared hole, with discharging chips toward a shank via the spiral flutes. FIG. 4A is a cross-sectional view showing one example of such a tapping procedure using the spiral fluted tap. The spiral fluted tap 100 has a threaded portion 102 formed with cutting edges extending along right-hand helix spiral flutes 104, and is rotatably driven clockwise as viewed from a shank 106 for tapping the internal threads. A worked material 110 is preliminarily formed with a prepared hole 112 into which the spiral fluted tap 100 is screwed at a distal end thereof to tap internal threads on an inner circumferential surface of the prepared hole 112.

During such tapping, the chips are discharged via the spiral flutes 104 to an outside of the prepared hole 112. However, when a full thread portion is screwed into a threaded hole 114 formed by a chamfer portion, the chips may be bitten to cause chipping of the cutting edges or breakage of the spiral fluted tap 100. Especially, as the spiral fluted tap dulls due to the use of water-soluble cutting oil and MQL (Minimum Quantity Lubrication) or the like, the chips hardly curled and extended lengthwise reveals an irregular movement. Thus, the chips are easily bitten to cause a remarkable possibility of the chipping of the cutting edges or the breakage of the spiral fluted tap.

On the contrary, Patent Publication 2 proposes a technology of preventing occurrence of chipping of the cutting edges at distal ends i.e., top ends. As shown in FIG. 4B, the threaded portion 102 includes a full thread portion having a chamfer-side thread portion 122 formed at side of the chamfer portion 120, and a shank-side thread portion 124 formed in an area closer to the shank 106. Except for two to five threads of the chamfer-side thread portion 122 contiguous to a distal end of the chamfer portion 120, crest portions of the shank-side thread portion 124, positioned radially outside of nearly an effective diameter are cut away (threads being removed). Thus, the occurrence of chipping of the cutting edges at distal ends thereof is prevented.

[Patent Publication 1] Japanese Patent Publication 4-75816

[Patent Publication 2] Japanese Patent Publication 10-118844

### DISCLOSURE OF THE INVENTION

### Subject to be Solved by the Invention

However, in the spiral fluted tap disclosed in Patent Publication 2, only the radially outward portions (outer diametric portion) positioned outside of the effective diameter are cut away. Therefore, even after such removal, the distal ends of the cutting edges are still sharp to easily bite the chips and to be easily chipped. Thus, the conventional spiral fluted tap was not be necessarily satisfied in an adequate manner.

The present invention has been completed considering with the above situations, and has an object to further effectively prevent occurrence of the chipping of the cutting edges and breakage of the spiral fluted tap resulted from the biting of cutting edges, encountered when screwing a full thread portion into a threaded hole formed by a chamfer portion.

### Means for Solving the Subject

For achieving the above object, a first aspect of the present invention relates to a spiral fluted tap which includes a threaded portion having cutting edges formed along spiral flutes formed to divide external threads, and being screwed into a prepared hole to cut internal threads by the cutting edges on an inner circumferential surface of the prepared hole with discharging chips toward a shank via the spiral flutes.

In the spiral fluted tap, (i) cutting faces of the cutting edges of a shank-side thread portion are formed with chamfers retreating circumferentially toward crests of the threads, and the shank-side thread portion is formed on a full thread portion of the thread portion, except for a chamfer-side thread portion having more than one thread and not more than five threads formed at a distal end contiguous to a chamfer portion and is closer to the shank than the chamfer-side thread portion; and (ii) each of the chamfers has a chamfer height Hmen ranging from 15% to 100% of a thread height Hneji of the full thread portion.

In a second aspect of the present invention, the chamfers are flat planar chamfers or arc R (round)-chamfers.

### EFFECT OF THE INVENTION

According to the spiral fluted tap, on the shank-side thread portion of the full thread portion of the threaded portion formed in the area closer to the shank, the cutting edges are formed with the chamfers. The chamfers have the cutting faces each having the chamfer height Hmen fallen within the range of 15% to 100% of the thread height Hneji. This allows the chips to be further easily pushed out toward an outer circumferential area i.e., space along the chamfers, respectively. In addition, the cutting edges can have the increased strength due to formation of the chamfers. This effectively prevents the occurrence of chipping of the cutting edges and breakage of the spiral fluted tap caused by the biting of the chips.

Further, the chamfer-side thread portion, formed on the full thread portion of the threaded portion at the distal end, is contiguous to the chamfer portion, which has an original complete thread configuration with more than one thread and not more than five threads. In addition, the shank-side thread portion formed with the chamfers has an original thread configuration except areas around the cutting edges, respectively. Thus, the entire area of the full thread portion can have the excellent guide action (in lead feed) than that achieved by a structure in which the crests of the threads are cut away in the cylindrical configuration in the areas radially outside the effective diameter. This can tap the internal threads with further increased precision

### BRIEF DESCRIPTION OF THE DRAWINGS

FIGS. 1A to 1C are views showing a spiral fluted tap of one embodiment according to the present invention; FIG. 1A being a front view; FIG. 1B being an enlarged view in cross section taken along a line B-B of FIG. 1A; and FIG. 1C being an enlarged view in cross section taken along a line C-C of FIG. 1A.

FIG. 2 is a view illustrating another embodiment in cross section corresponding to that shown in FIG. 1C.

FIGS. 3A and 3B are tables illustrating results on durability tests conducted on test pieces Nos. 1 to 10, involving products of the present invention, of ten kinds using two pieces respectively; FIG. 3A being a table illustrating specifications of the test pieces of the ten kinds; and FIG. 3B being a table showing test results on durability tests.

FIGS. 4A and 4B are views illustrating a conventional spiral fluted tap; FIG. 4A being a cross sectional view showing a status under which a thread portion is screwed into a prepared hole for tapping; and FIG. 4B being a front view showing the spiral fluted tap a full thread portion is cut away in a cylindrical manner for preventing chips from being bitten.

### EXPLANATION OF REFERENCES

10: spiral fluted tap
16: thread portion
20: spiral flute
24: full thread portion
24a: chamfer-side thread portion
24b: shank-side thread portion
26: cutting edge
30: chamfer (flat planar chamfer)
32: R-chamfer (chamfer)
O: axis
Hmen: chamfer height
Hneji: thread height θ: chamfer angle

### BEST MODE FOR CARRYING OUT THE INVENTION

A spiral fluted tap of the present invention allows chips to be discharged toward a shank. More particularly, the spiral fluted tap is in one style formed cutting edges along right-hand spiral flutes to be rotatably driven clockwise as viewed from the shank to perform cutting work. In the other style, the spiral fluted tap has cutting edges formed along left-hand spiral flutes to be rotatably driven counter-clockwise as viewed from the shank to perform cutting work.

The spiral fluted tap can be made of tool material such as, for instance, high-speed tool steel (high speed steel) or cemented carbide steel or the like and possibly applied with hard coating of TiAlN, TiN, TiCN or the like depending on needs. Further, the spiral fluted tap of the present invention demonstrates excellent advantageous effects particularly when the chips easily extend lengthwise to irregularly move due to dulling of the spiral fluted tag encountered in the tapping with the use of water-soluble oil-based cutting agent, MQL (Minimum Quantity Lubrication) or oil-less dry machining. However, of course, the spiral fluted tap of the present invention can be used for tapping under wet working supplied with lubricating oil-based agent at an adequate feed rate.

If a chamfered-side thread portion, having cutting faces not formed with the chamfer, of a full thread portion has less than one thread, the spiral fluted tap is hardly guided (in lead feed) with increased precision. Meanwhile, if the chamfered-side thread portion has more than five threads, then, the chamfered-side thread portion will easily bite the chips, causing the chipping of the cutting edges or breakage of the spiral fluted tap. Therefore, the chamfered-side thread portion needs to have more than one thread and not more than five (5) threads i.e., five or smaller than five.

A chamfer height Hmen of the chamfer refers to a radial dimension measured based on a distal end (outer circumferential edge) of each cutting edge before the distal ends i.e., radially top ends being chamfered. A thread height Hneji of the full thread portion refers to a radial dimension of a thread between a root and top thereof, and it is particularly represented in terms of “(Tap Outer Diameter−Tap Root Diameter)/2”. If the chamfer height Hmen is less than 15% of the thread height Hneji, the chamfer can not suppress the biting action of the chips, and can not render adequate improved strength of the cutting edges. In contrast, if the chamfer height Hmen exceeds 100% of the thread height Hneji, then, a gap is created between the prepared hole (threaded hole) and the spiral fluted tap with an adverse effect of easily biting the chips. Therefore, the chamfer height Hmen needs to fall in a range between 15% and 100% of the thread height Hneji. The chamfer height Hmen may be fixed i.e., constant in value but may be possibly varied in an axial direction within a predetermined range in a continuous or stepwise manner. Alternatively, the chamfer height Hmen may have differing dimensions different for plural cutting edges, respectively.

Chamfered shapes may have flat planar chamfer, or arc R-chamfer. The flat planar chamfer will be described below in detail with reference to a case wherein each flat planar chamfer has a chamfer angle θ angled with respect to a base line L connecting between a radial distal end i.e., top end (outer circumferential edge) of the cutting edge before the chamfering and a tapping axis O, in a cross section perpendicular to each cutting edge. If the chamfer angle θ is too small, then the chamfer can not render the suppressing action of the biting of the chips, and can improve the strength of the cutting edge by the chamfer. Thus, the chamfer angle θ may preferably be selected to fall in a value of, for instance, 20° or more.

On the contrary, if the chamfer angle θ is too large, then, the spiral fluted tap has a decreased angle between the chamfer and the cutting face, easily catching the chips with increased likelihood. Thus, the chamfer angle θ may preferably be selected to fall in a value of, for instance, 60° or less. Although the chamfer angle θ may have a fixed value, it may be possibly varied within a predetermined range along an axial direction in a continuous or stepwise manner. In an alternative, the chamfer angle θ may have differing dimensions different for plural cutting edges, respectively.

The R-chamfer is formed in a circular arc configuration with a radius being nearly fixed such that the R-chamfer is smoothly connected to the cutting face and the crest of the thread, in a cross section perpendicular to, for instance, the cutting edge. However, the R-chamfer may have a circular arc configuration with the radius of the curvature varying continuously due to a convenience of working.

Threads of the full thread portion may preferably have thread reliefs i.e., reliefs such as eccentric reliefs or the like, respectively. In an alternative, threads of a fixed diametrical dimension with no reliefs can be adopted. That is, it may suffice for the spiral fluted tap of the present invention to have the chamfers formed on the cutting faces of the cutting edges of the shank-side thread portion of the full thread portion, and for the thread reliefs to take a variety of designs including presence/absence of the thread reliefs. For instance, areas of the threads in close proximity to the crests can be cut away into cylindrical configurations.

A flute angle of the spiral flute provided on the threaded portion may preferably be selected to range from approximately, for instance, 15° to 50°. Moreover, the number of teeth of the cutting edges is appropriately varied to have, for instance, about 2 to 6 cutting edges depending on work material to be cut or a tapping size.

### Embodiment

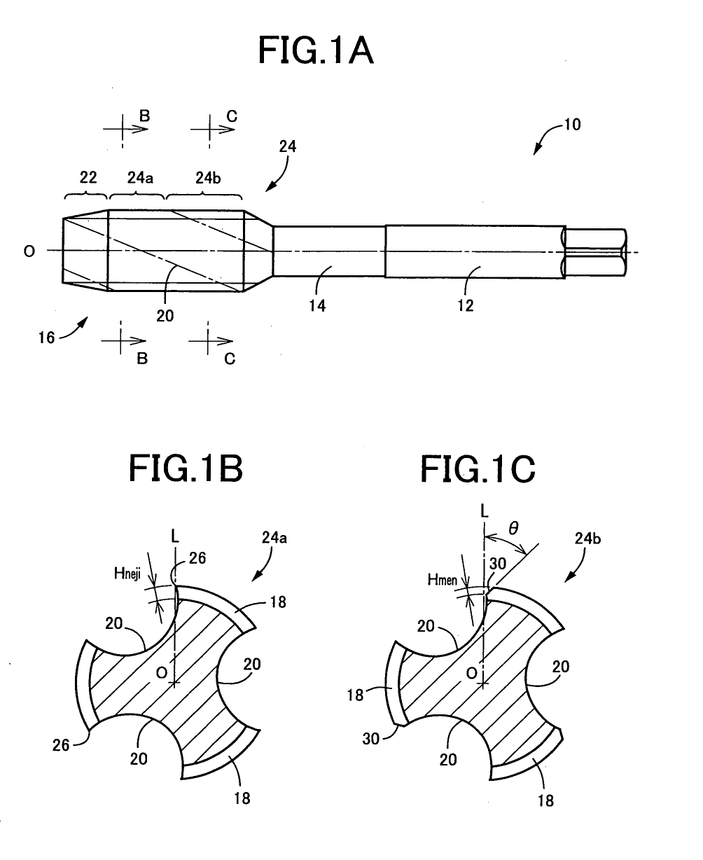

Hereunder, embodiments of the present invention will be described below in detail with reference to the accompanying drawings. FIGS. 1A to 1C are views showing a spiral fluted tap of one embodiment according to the present invention; FIG. 1A being a front view; FIG. 1B being an enlarged view in cross section taken along a line B-B of FIG. 1A; and FIG. 1C being an enlarged view in cross section taken along a line C-C of FIG. 1A.

A spiral fluted tap 10 includes a shank 12, a neck portion 14 and a threaded portion 16, which are integrally formed on a common axis O in such an order. The threaded portion 16 has external threads formed in groove profiles corresponding to internal threads to be cut, and three spiral flutes 20 formed so to divide the external threads. The threaded portion 16 includes a chamfer portion 22 formed at an axial distal end thereof with threads 18 of the external threads being removed in the axial direction in a tapered shape, and a full thread portion 24 contiguous to the chamfer portion 22 and having the full threads 18. Cutting edges 26 are formed at ridgelines between the threaded portion 16 and the spiral flutes 20.

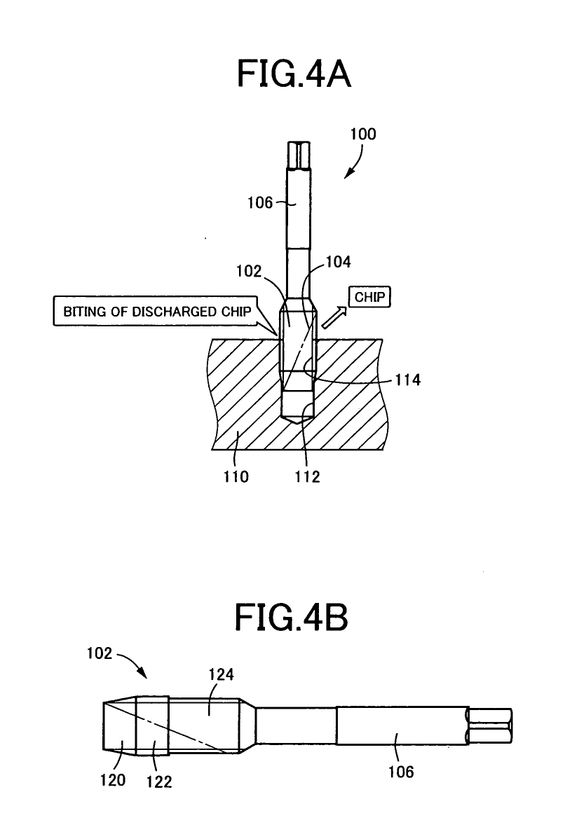

The spiral flutes 20 are right-hand helixes each of which has a helix angle falling within a range of, for instance, 15° to 50° to lie at a value of approximately, for instance, 40°. In use, the spiral fluted tap 10 is rotatably driven clockwise as viewed from the shank 12 so that a distal end is screwed into, for instance, the prepared hole 112 of the work material 110 shown in FIG. 4A. Thus, the internal threads are cut on an inner circumferential surface of the prepared hole 112 with the spiral flutes 20 permitting chips to be discharged toward the shank 12.

The full thread portion 24 has chamfers i.e., chamfered portions 30. Each of these chamfers 30 is formed on a cutting face i.e., rake face (forming part of each spiral flute 20) of the cutting edge 26 of a shank-side thread portion 24b formed in an area closer to the shank 12, except for a chamfer-side thread portion 24a. The chamfer-side thread portion 24a is formed on the full thread portion 24 in an end portion thereof to be contiguous to the chamfer portion 22 and has more than one threads and not more than five threads. The chamfers 30 are retreated circumferentially (to heel side) toward the crests i.e., outer circumferences of the threads 18. That is, the chamfers 30 are inclined circumferentially (to heel side) as distance from the axis increases. FIG. 1B is a cross-sectional view of the chamfer-side thread portion 24a which has no chamfers 30. FIG. 1C is a cross-sectional view of the shank-side thread portion 24b in which the chamfers 30 are provided. The chamfer 30 has a chamfer height Hmen determined to lie in a value of about, for instance, 50% falling in a value ranging from 15% to 100% of a thread height Hneji of the full thread portion 24. The chamfer height Hmen represents a radial dimension of the chamfer measured based on a distal end i.e., radially top end (outer circumferential edge) of each cutting edge 26 prior to the formation of each chamfer. The thread height Hneji represents a radial dimension of the thread 18 from a root to a crest that is concretely expressed by the relationship (Tap Outer Diameter−Tap Root Diameter)/2.

The chamfer 30 is a flat planar chamfer having a chamfer angle θ, angled with respect to a base line L connecting between the distal end (outer circumferential edge) of the cutting edge 26 prior to the chamfer formation and a tap axis O, which lies in a value of approximately, for instance, 45° within a range of 20° to 60°. The chamfer angle θ is indicated in a cross section perpendicular to the axis O in FIG. 1C. Strictly speaking, however, the chamfer angle θ represents an angle in cross section perpendicular to the cutting edge 26 formed along each spiral flute 20 and falls in a value ranging from 20° to 60°.

In the illustrated embodiment, both the chamfer height Hmen and the chamfer angle θ are set in fixed dimensions at fixed angles over an entire area of the shank-side thread portion 24b. In the illustrated embodiment, further, the spiral fluted tap 10 is made of high-speed tool steel (powdered high-speed steel) with the threaded portion 16 having a hard coating of TiCN. Although each of the threads 18 of the full thread portion 24 in FIGS. 1B and 1C each has a profile extending to a heel with a fixed radial dimension with no chamfer relief, the thread 18 may have a relief such as an eccentric thread relief or the like depending on needs. The threads 18 of the chamfer portion 22 are formed with predetermined reliefs, respectively.

According to the spiral fluted tap 10 of the present invention, of the full thread portion 24 of the threaded portion 16, the cutting edges 26 of the shank-side thread portion 24b formed in the area closer to the shank 12 are formed with the chamfers 30. The chamfer 30 have the cutting faces each having the chamfer height Hmen fallen within the range of 15% to 100% of the thread height Hneji. This allows the chips to be further easily pushed out toward an outer circumferential area i.e., space along the chamfers 30, respectively. In addition, the cutting edges 26 can have the increased strength thanks to formation of the chamfers 30. This effectively prevents the occurrence of chipping of the cutting edges and breakage of the spiral fluted tap caused by the biting of the chips. Thus, the spiral fluted tap has the increased durability (operating life).

Further, of the full thread portion 24 of the threaded portion 16, the chamfer-side thread portion 24a formed on the full thread portion 24 at the axial distal end thereof is contiguous to the chamfer portion 22, which has an original complete thread configuration with more than one thread and not more than five threads. In addition, the shank-side thread portion 24b formed with the chamfers 30 has an original thread configuration except areas around the cutting edges 26, respectively. Thus, the entire area of the full thread portion 24 can have the more excellent guide actions (in lead feed) than that achieved by a structure in which the crests of the threads are cut away in the cylindrical configuration in the areas radially outside the effective diameter. This can tap the internal threads with further increased precision.

Furthermore, in the present embodiment, the chamfer 30 formed in the flat planar chamfer has the chamfer angle θ falling in a value ranging from 20° to 60°. The chamfer angle θ allows the chamfers 30 to appropriately obtain the suppression action of the biting of the chips, and to improve strength of the cutting edges. Thus, the spiral fluted tap has the increased durability.

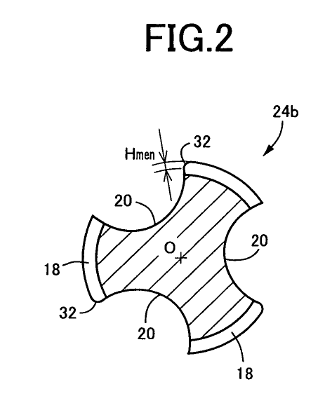

While in the illustrated embodiment, the chamfers 30 are formed in the flat planar chamfers, respectively, R-chamfers 32 i.e., round chamfer 32 may be provided as shown in FIG. 2. The R-chamfers 32 are formed on the spiral flutes 20 in cross section perpendicular to the cutting edge 26, respectively, to be smoothly contiguous to the cutting faces (spiral flutes 20) and the crests of the threads 18. Each of the R-chamfers 32 each has a circular arc with, for instance, a nearly fixed curvature.

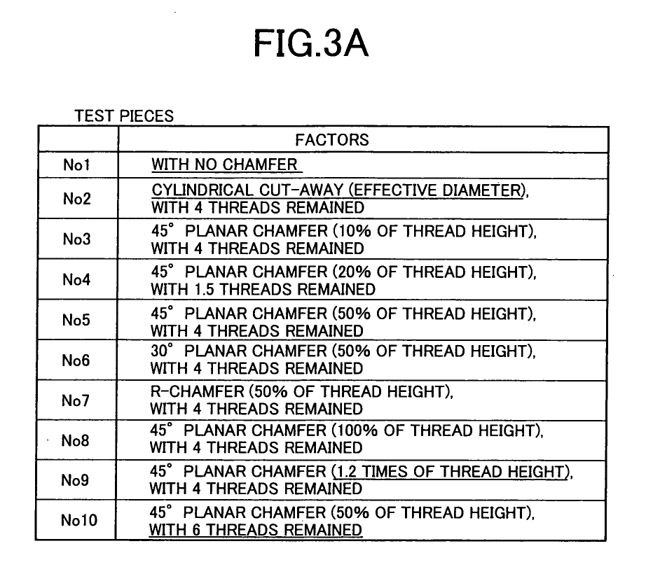

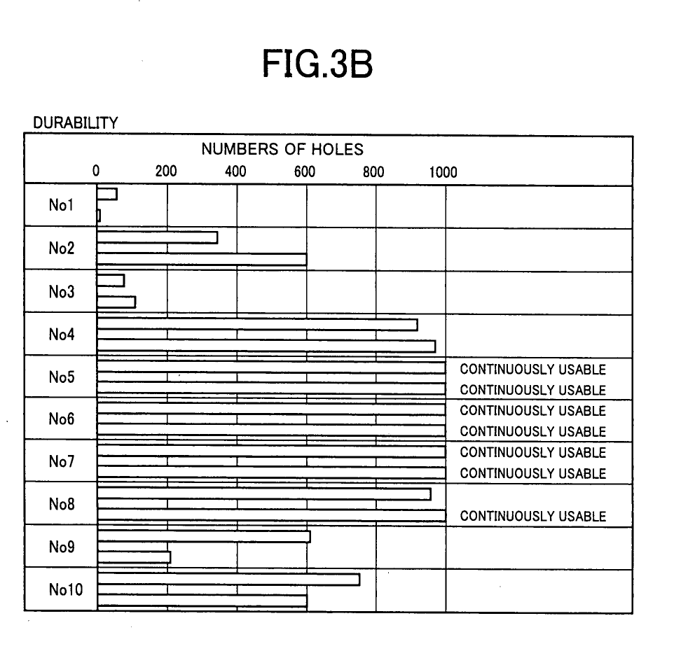

FIGS. 3A and 3B are tables illustrating test results on ten kinds of test pieces Nos. 1-10 involving the test pieces of the present invention, each prepared in two pieces, and respective test pieces were used for tapping under a cutting condition listed below to check durability thereof. FIG. 3A is a table illustrating specifications of the test pieces of ten kinds. FIG. 3B is a table showing test results of the test pieces with durability being checked in terms of the presence/absence of the chipping or the breakage.

(Cutting Condition)

Size: M8×1.25

Worked Material: SUS304

Cutting Speed: 8 m/min

Shape of Prepared Hole: Through-hole with φ6.8×25 mm

Effective Length of Threads: 16 mm (two times that of tool diameter)

Cutting Fluid Water-Soluble Cutting Oil

Machine used: Transverse type Machining Center

The test pieces Nos. 1-10 have the same fundamental shapes as that of the spiral fluted tap 10 of the present embodiment. In FIG. 3A, underlined parts indicate items different from the present invention. That is, the test pieces No. 1 represent the conventional products in which the chamfers 30 or 32 are not provided. The test pieces No. 2 represent the conventional products disclosed in Patent Publication 2. Each of them includes the chamfer-side thread portion 24a having four threads, and the shank-side thread portion 24b having the crests being cut away in the cylindrical shape at areas radially exceeding the effective diameter. The test pieces No. 3 represent comparison products each including the chamfer-side thread portion 24a having the four threads and having the chamfer of the chamfer angle θ=45°. However, the chamfer height Hmen with 10% of a thread height Hneji is too small.

All the test pieces Nos. 4-8 represent products of the present invention, each formed with the chamfer-side thread portion 24a having 1.5 threads or four threads, each having the flat chamfers with the chamfer angle θ of 30° or 45° or the R-chamfers formed in the circular arc configurations, and each of the chamfer heights Hmen has value of 20%, 50% and 100% the thread height Hneji, respectively. The test pieces No. 9 represent comparison products, each formed with the chamfer-side thread portion 24a having four threads, each having the chamfers with a chamfer angle θ=45°, and a chamfer height Hmen is too large with a value 1.2 times the thread height Hneji. The test pieces No. 10 represent comparison products, each having a chamfer angle θ=45°, and a chamfer height Hmen is 50% of the thread height Hneji. However, the chamfer-side thread portion 24a has too many number of threads with six threads.

As will be apparent from the test results shown in FIG. 3B, all the test piece Nos. 4-8 of the present invention can tap more than 900 holes. Particularly, the test pieces Nos. 5-7 still remained operative to successively tap holes even after they tapped 1000 holes. On the contrary, one of the test pieces No. 1 of the conventional art is damaged merely upon tapping 56th holes. One of the test pieces No. 2, having the effective diametric portion cut away in the cylindrical shape, is damaged upon tapping 598th holes. Although this test piece No. 2 revealed further remarkably increased durability than those of the test pieces No. 1, such a result was nearly half that of durability of the products (test pieces Nos. 5-8) of the present invention.

Further, one of the comparison products of the test pieces No. 3 is damaged upon tapping 108th holes, and can not improve the durability with the provision of the chamfers 30. Furthermore, ones of the comparison products of the test pieces Nos. 9 and 10 can tap 608 and 705 holes, respectively. Although these test pieces had effects of improving durability at certain degrees, they revealed no remarkable difference as compared to the results of the comparison products of the test pieces No. 2.

In the foregoing, while the present invention has been described above with reference to the accompanying drawings, it is intended that the embodiment described be considered only as illustrative of the present invention and that the present invention may be implemented in various modifications and improvements based on knowledge of those skilled in the art.

### INDUSTRIAL APPLICABILITY

In the spiral fluted tap, on the full thread portion of the threaded portion, the cutting edges of the shank-side thread portion formed in the area closer to the shank are formed with the chamfers. The chamfers have the cutting faces each having the chamfer height Hmen fallen within the range of 15% to 100% of the thread height Hneji. This allows the chips to be further easily pushed out toward an outer circumferential area along the chamfers. In addition, the cutting edges can have the increased strength thanks to formation of the chamfers. This effectively prevents the occurrence of chipping of the cutting edges and breakage of the spiral fluted tap caused by the biting of the chips. Thus, the spiral fluted tap can be preferably used for the tapping.

1. A spiral fluted tap which includes a threaded portion having cutting edges formed along spiral flutes formed to divide external threads, and being screwed into a prepared hole to cut internal threads by the cutting edges on an inner circumferential surface of the prepared hole with discharging chips toward a shank via the spiral flutes, comprising:
cutting faces of the cutting edges of a shank-side thread portion being formed with chamfers retreating circumferentially toward crests of the threads, and the shank-side thread portion being formed on a full thread portion of the thread portion, except for a chamfer side thread portion having more than one thread and not more than five threads formed at a distal end contiguous to a chamfer portion and being closer to the shank than the chamfer-side thread portion; and
each of the chamfers having a height Hmen ranging from 15% to 100% of a thread height Hneji of the full thread portion.

2. The spiral fluted tap according to claim 1, wherein the chamfers are flat planar chamfers or arc R-chamfers.

3. The spiral fluted tap according to claim 1, wherein the chamfers are flat planar chamfers formed such that a chamfer angle ranges from 20° to 60° in a cross section perpendicular to the cutting edges formed along the spiral flutes.

4. The spiral fluted tap according to claim 1, wherein a flute angle of the spiral flutes ranges from 15° to 50°.

5. The spiral fluted tap according to claim 1, wherein the number of cutting edges ranges from 2 to 6.
